(19) United States
(12) Patent Application Publication
(10) Pub. No.: US 2004/0023781 A1
(43) Pub. Date: Feb. 5, 2004

(54) Centrifugal separator and its scraping device

(76) Inventors: Kei Mukai, Katano-shi, Osaka (JP); Yoshio Nishida, Osaka-shi, Osaka (JP)

Correspondence Address: WENDEROTH, LIND & PONACK, L.L.P., 2033 K STREET N. W., SUITE 800, WASHINGTON, DC, 20006-1021, US

(21) Appl. No.: 10/416,221

(22) PCT Filed: Dec. 28, 2001
(86) PCT No.: PCT/JP01/11609

(30) Foreign Application Priority Data
Dec. 28, 2000 (JP) 2000-400479

(51) Int. Cl. B04B 11/08

(52) U.S. Cl. 494/37; 494/56; 494/58

(57) ABSTRACT

The centrifugal separator (10) has a scraper (60) for peeling and separating the solid content (94) which is accumulated in the vicinity of the peripheral wall (28) of the container (16) in association with the rotation of the container (16). This scraper (60) is provided with a guide portion (62) which changes the flow of a liquid whirling in the annular space (32) in association with the rotation of the container (16) and allows the liquid to flow obliquely and downwardly onto the solid content (94).

### FIELD OF THE INVENTION

The present invention relates to a centrifugal separator, a scraping device for use in the centrifugal separator, and a method for collecting a solid content separated in the centrifugal separator.

### BACKGROUND OF THE INVENTION

In the process of manufacturing microcapsules, the microcapsules are first prepared by an in-liquid drying method in a certain liquid and then separated by a centrifugal separator from the liquid. For this separation, there -have been proposed various types of centrifugal separators. Among others, one conventional centrifugal separator has a vertical shaft drivingly connected to a drive mechanism and a container securely mounted on the vertical shaft so that it rotates with the shaft. With this arrangement, a suspension made of the liquid and the solid content (i.e., microcapsules) dispersed in the liquid is supplied into an annular chamber defined by top and bottom walls and peripheral wall connecting between the top and bottom walls of the container. When the container is rotated with the rotation of the shaft, the solid content is accumulated onto an inner surface of the peripheral wall by a centrifugal force generated by the rotation and then scraped away from the wall by using, for example, a comb-like scraper. At this scraping, an excessive biasing of the scraper against the accumulated solid content may disadvantageously result in an agglomeration of the microcapsules, in which each of the agglomerated microcapsules is incapable of being separated from another.

### SUMMARY OF THE INVENTION

Therefore, a centrifugal separator (10) according to the present invention has a vertical shaft (14) connected to a driving system (15) and a container (16) which rotates together with the vertical shaft (14). The container (16) includes a round base plate (26) centering on the vertical shaft (14), a peripheral wall (28) extending substantially parallel to the vertical shaft (14) and upwardly from a peripheral edge of the base plate (26), and an annular top plate (36) extending inwardly from an upper end of the peripheral wall (28) toward the vertical shaft (14) and having therein a round opening (31) centering on the vertical shaft (14), so that the annular top plate (30) cooperates with the base plate (26) and the peripheral wall (28) to defines an annular space (32) therebelow. Thereby, a suspension (92) made of a liquid and solid content and supplied into the container (16) is held in the annular space (32) and the solid content (94) is accumulated on the peripheral wall (28) by a centrifugal force caused by the rotation of the vertical shaft (14).

In particular, the centrifugal separator (10) has a scraper (60) for scraping and separating an accumulation of the solid content (94) into pieces, the scraper (60) having a guide portion (62) which orients a liquid stream caused in the annular space (32) by the rotation of the container (16) and running in a peripheral direction into a downward, oblique direction toward the peripheral wall (28).

### BRIEF DESCRIPTION OF THE DRAWINGS

FIG. 1 is a cross-sectional view of a centrifugal separator according to the present invention, in which a scraping device of the present invention is removed therefrom;

FIG. 2 is a plan view of the centrifugal separator shown in FIG. 1;

FIG. 3 is a side elevational view of the scraping device;

FIG. 4A is a partial plan view of the centrifugal separator according to the first embodiment;

FIG. 4B is a side elevational view of the scraping device of the centrifugal separator shown in FIG. 4A;

FIG. 4C is a plan view of the scraper;

FIG. 5A is a cross-sectional view of the scraper;

FIGS. 5B to 5F are side elevational views of the scrapers in different angles;

FIG. 6 is a side elevational view of a skimming device;

FIG. 7 is a side elevational view of a liquid-transport device;

FIG. 8A is a partial plan view of a centrifugal separator according to the second embodiment;

FIG. 8B is a side elevational view of the scraping device of the centrifugal separator shown in FIG. 8A; and

FIG. 9A is a partial plan view of a centrifugal separator according to the third embodiment;

FIG. 9B is a side elevational view of the scraping device of the centrifugal separator shown in FIG. 9A;

FIG. 9C is a side elevational view of the scraper shown in FIGS. 9A and 9B;

FIG. 9D is a partial side elevational view of the scraper shown in FIGS. 9A and 9B;

FIG. 9E is a cross-sectional view of the scraper shown in FIGS. 9A and 9B;

FIG. 9F is a partial side elevational view of the scraper shown in FIGS. 9A and 9B; and

FIG. 10 is a schematic plan view of the centrifugal separator, showing an angle defined by a peripheral end surface of the teeth and a tangential line of the inner surface of the accumulation.

### DETAILED DESCRIPTION OF THE PREFERRED EMBODIMENTS

The present application is based upon the Japanese Patent. Application No. 2000-400479, which is entirely incorporated herein by reference.

With reference to the accompanying drawings, the present invention will be described in detail by way of several embodiments according to the present invention below. It is to be understood that the following embodiments should not be construed as limiting the scope of the present invention.

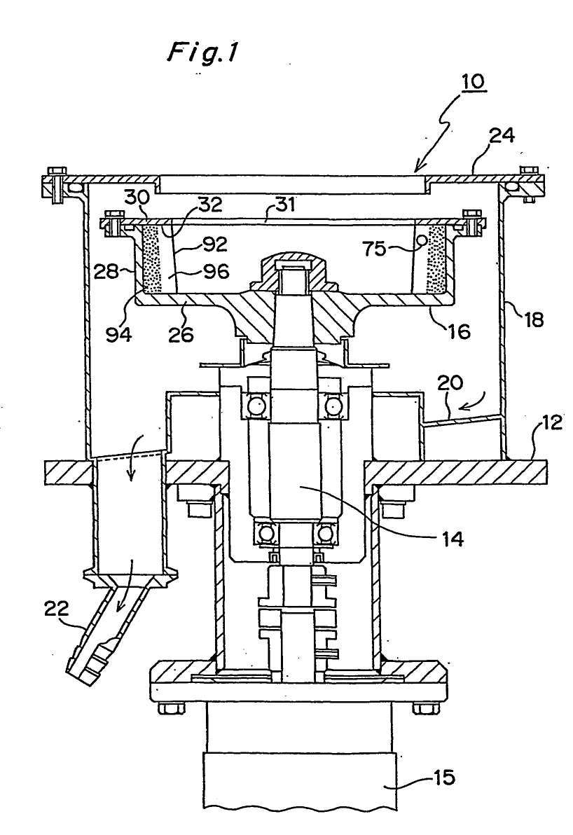

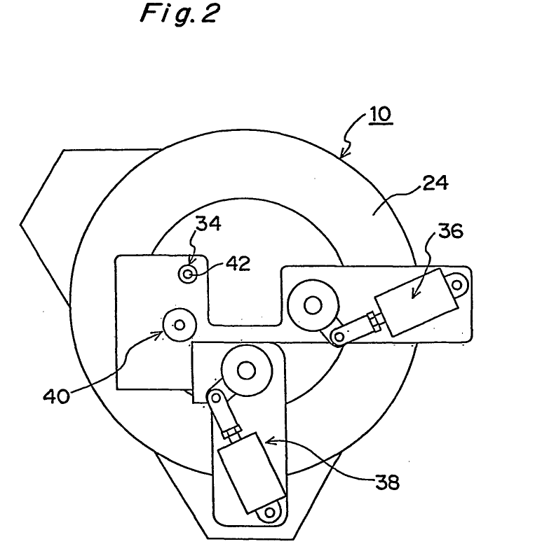

FIGS. 1 and 2 show a centrifugal separator (10) for separating and collecting microcapsules with sizes smaller than a predetermined dimension from a suspension containing liquid (e.g., water) and microcapsules prepared by the in-liquid drying method. The centrifugal separator (10) has a base frame (12) supported on a fixed bed (now shown). The base frame (12) rotatably supports a vertical shaft (hereinafter referred to as “rotation shaft”) (14) extending vertically. The rotation shaft (14), which is connected at its lower end to a rotation drive system including a motor (15), supports a container (hereinafter referred to as “basket”) (16) at its upper portion.

The base frame (12) has a cylindrical housing (18) enclosing the basket (16). A base plate (20) of the housing (18) is slanted for collecting a liquid overflowed from the basket (16) and guiding the collected liquid through a pipe (a collecting passage) connected to the lowermost portion of the base plate (20). A top or support plate (24) defined with an opening and located above the basket (16) is removably mounted on the upper end of the housing (18) for supporting various devices described below.

The basket (16) has a disk-like base plate (26) supported by the rotation shaft (14), a peripheral wall (cylindrical wall) (28) extending coaxially with the rotation shaft (14) and upwardly from the circumferential edge of the base plate (26) and an annular top plate (30) removably supported by the upper end of the peripheral wall (28). The base plate (26), the peripheral wall (28) and the annular portion of the base plate (26) confronting the top plate (30) define an annular space (32) inside the peripheral wall (28). The annular top plate (30) has a round opening (31) centering on the rotation shaft (14), allowing the plurality of devices mounted the support plate (24) to be extended into an interior of the basket (16) through the opening (31).

With reference to FIG. 2, the support plate (24) supports thereon a suspension-supplying device (34), a scraping device (36), a skimming device (38), a liquid-transport device (40) and a cleaning device (not shown). The suspension-supplying device (34) has a suspension-feeding nozzle (42), through which a suspension containing a certain liquid with microcapsules prepared by the in-liquid drying method is supplied into the basket (16).

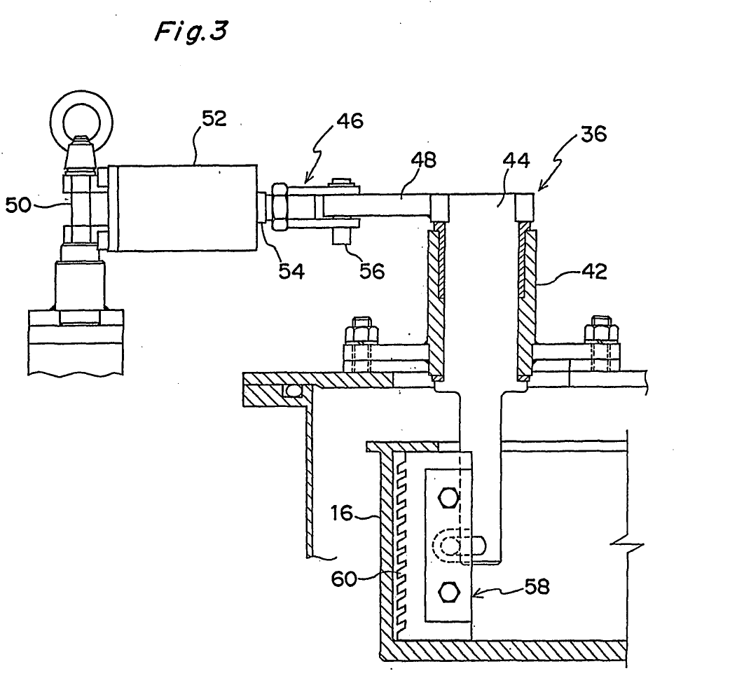

With reference to. FIG. 3, the scraping device (36) fixedly supports a bearing sleeve (42) extending vertically and parallel to the rotation shaft (14), at a position spaced a predetermined distance in the radial direction and outwardly from the rotation shaft (14). The baring sleeve (42) rotatably supports a vertical shaft (44). The vertical shaft (44) is connected to a transport device (hereinafter referred to “rotation mechanism”) (46) which rotates the vertical shaft (44) a predetermined angle on the longitudinal axis of the shaft (44). The rotation mechanism (46) has a lever (48) extending horizontally from the upper end of the vertical shaft (44), a vertical supporting shaft (50) fixed to the support plate (24), a cylinder (52) connected to the vertical supporting shaft (50) which rotates therearound, and a pin (56) rotatably connecting the plunger (54) of the cylinder (52) to the free end of the lever (48). With this arrangement, by extending and retracting the plunger (54) of the cylinder (52) in association with the driving of the cylinder (52), the vertical shaft (44) is rotated the predetermined angle in a clockwise and counterclockwise direction.

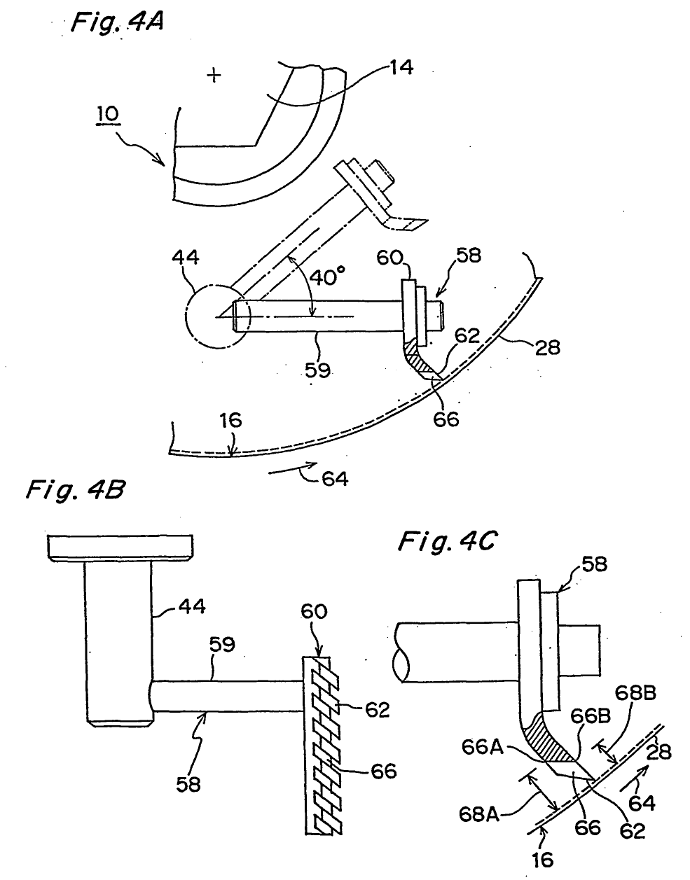

A scraping portion (58) is connected to the lower end of the vertical shaft (44). As shown in detail in FIG. 4, the scraping portion (58) has a horizontal support (59) extending in the radial direction and outwardly from the vertical shaft (44), and a scraping plate or scraper (60) removably secured to the tip end of the horizontal support (59). This allows that, by the driving of the cylinder (52), the scraper (60) swings horizontally between a first position close to the inner periphery of the wall (28), indicated by the solid line in FIG. 4A (the foremost or extended position), and a second position spaced away from the wall (28), indicated by the long and short dotted line (the rearmost or retracted position). In this embodiment, the scraper (60) is designed to swing within an angle of 40 (about the vertical shaft (44).

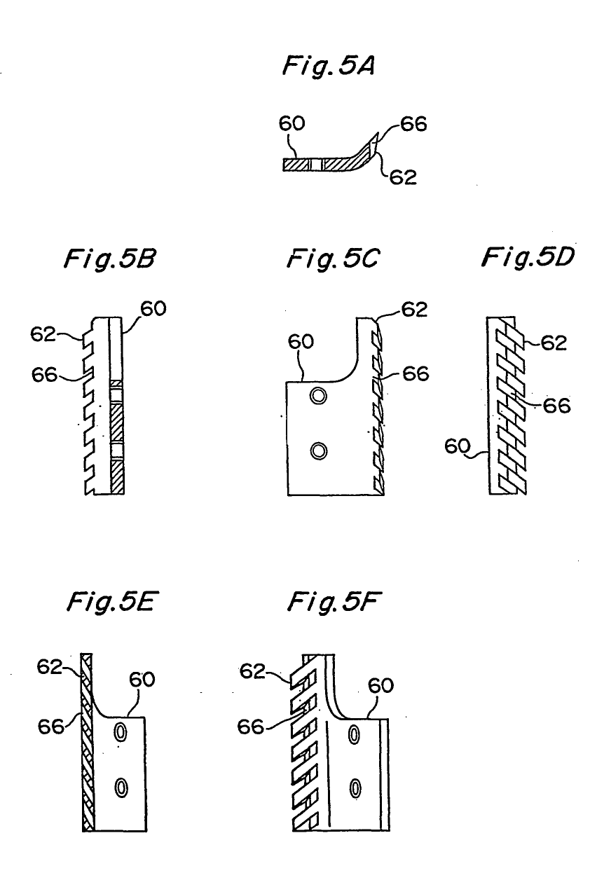

As shown in FIGS. 4A-4C and 5A-5F, the comb-like scraper (60), which is angled at its mid portion when viewed from above, has a plurality of projection or teeth (62) formed in its radial end opposing to the peripheral wall (28) of the basket (16) at regular intervals in the vertical direction. As can be seen from above, each tooth (62) is configured so that it tapers toward the inner wall of the basket (16). Each groove (66) defined by the neighboring teeth (62) extends in the rotating direction of the basket (16) indicated by arrow (64). As best shown in FIG. 4C, a bottom surface of each groove (66) opposing to the peripheral wall (28) is inclined relative to the normal line of the inner peripheral surface of the basket (16) so that a distance (68A) between the basket (16) and the inlet (66A) of the groove (66) at one end of the groove (66) on the upstream side relative to the rotating direction of the basket (16) is greater than a distance (68B) between the basket (16) and the outlet (66B) at the other end of the groove (66) on the downstream side. Besides, as best shown in FIG. 4B, each groove (66) is inclined downwardly toward the rotational direction of the basket (16) indicated by arrow (64). For example, the angle of inclination of the grooves (66) set to be about 35° relative to a horizontal plane.

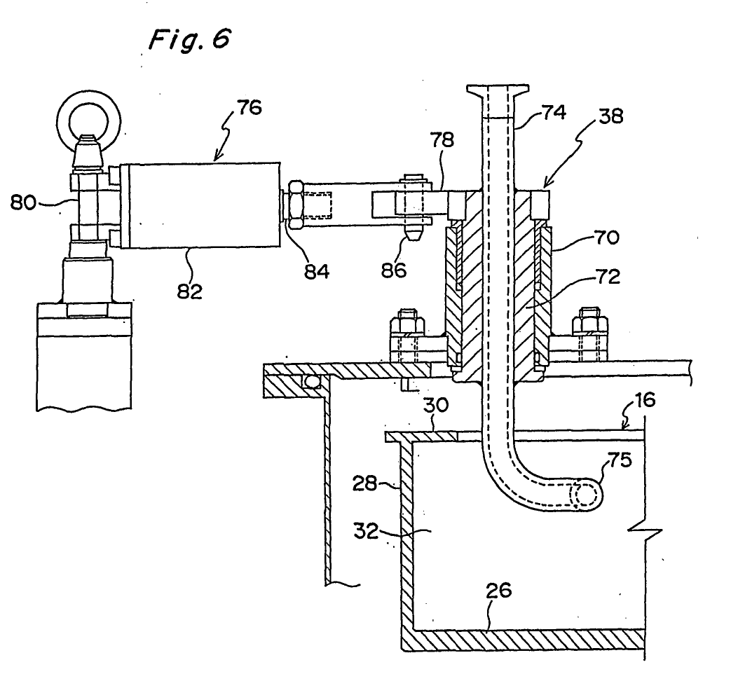

As shown in FIG. 6, the skimming device (38) has a bearing sleeve (70) secured to the support plate (24) and spaced a certain distance in a horizontal direction from the rotation shaft (14). The bearing sleeve (70), which extends vertically and parallel to the rotation shaft (14), bears a cylindrical nozzle holder (72) therein so that the nozzle holder (72) rotates about a longitudinal vertical axis thereof. The nozzle holder (72) in turn holds a skimming pipe or nozzle (74). An upper end of the skimming nozzle (74) is opened to the air. The other, lower end (75) of the skimming nozzle (74) positioned in the interior of the basket (16) is angled and then directed horizontally.

The nozzle holder (72) is connected to a transport device (hereinafter referred to as “rotation mechanism”) (76) which rotates the nozzle holder (72) and the skimming nozzle (74) a predetermined angle on a horizontal plane. The rotation mechanism (76) has the same structure as that of the rotation mechanism (46) of the scraping device (36). Namely, the rotation mechanism (76) has a lever (78) extending in a horizontal direction from the upper end of the nozzle holder (72), a vertical supporting shaft (80) fixed on the support plate (24), a cylinder (82) connected to the vertical supporting shaft (80) so that it rotates about the shaft (80) as the center, and a pin (86) for rotatably connecting the plunger (84) of the cylinder (82) to the free end of the lever (78).

With the arrangement, when the plunger (84) is extended or retracted in association with the driving of the cylinder (82), the tip end (the lower end portion) (75) of the skimming nozzle (74) moves between a position inside the annular space (32) inside the basket (16) (see FIG. 1) and a position outside the annular space (32).

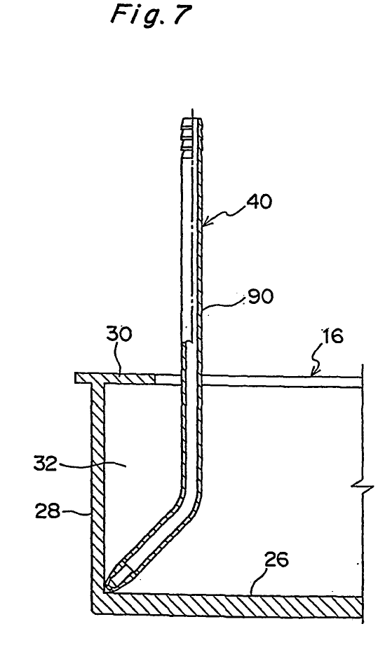

As shown in FIG. 7, the liquid-transport device (40) has a liquid-transport pipe (90) extending vertically. The liquid-transport pipe (90) is supported by a supporting mechanism (not drawn) so that the pipe (90) can freely move up and down and also that the pipe (90) can freely rotate so as to allow the opening of the tip end (the lower end) of the pipe (90) to move between a position inside the annular space (32) in the basket (16) and a position outside the annular space (32).

The cleaning device not shown for clarity of the drawings has a nozzle which supplies cleaning water into the basket (16) after the centrifugal separation of the microcapsules.

In-operation of the centrifugal separator (10) so constructed, the basket (16) rotates in the direction indicated by arrow (64) by the driving of the motor (15) (see FIG. 4A). At this moment, the scraping device (36) is positioned at the retracted position indicated by the long and short dotted line shown in FIG. 4A. The skimming nozzle (74) takes the retracted position so that its tip end (75) positions outside the annular space (32), or within a region enclosed by the annular space (32). In this state, a suspension containing the liquid with microcapsules prepared by the in-liquid drying method is supplied into the basket (16) through the suspension-supplying nozzle (42). The supplied suspension is subject to a centrifugal force radially and outwardly by the rotation of the basket (16). This causes the suspension to be held in the annular space (32) in the basket (16) as shown in FIG. 1. Also, the microcapsules (94) or the solid content of the suspension (92) are accumulated on the interior surface of the peripheral wall (28) by the centrifugal force. The liquid or supernatant (96) separated from the microcapsules is held on the accumulated microcapsules (94). The limited volume of the annular space (32) causes the excessive supernatant (96) to overflow beyond the inner-edge of the annular plate (30) onto the slanted base plate (20) of the housing (18), which is then collected and discharged through the waste liquid outlet (22).

After the completion of the supply of the suspension, the skimming nozzle (74) moves its tip end (75) into the annular space (32). At this stage, since the basket (16) is still at rotation, the liquid held in the annular space (32) by the centrifugal force is transported in the basket-rotating direction indicated by arrow (64) due to the frictional contact with the interior surface of the basket. This allows that the supernatant (96) being transported with the rotation of the basket (16) flows into the skimming nozzle (74) through its tip end (75) and then discharged outside the basket (16) from the opening of the upper end of the skimming nozzle (74).

By the driving of the cylinder (52), the scraping device (36) gradually moves the scraper (60) from the retracted position indicated by the imaginary line toward extended position indicated by the solid line. The scraper (60) may be moved continuously without any halt or intermittently repeating stops and halts alternately. At this moment, the liquid adjacent to the scraper (60) moves along the groove (66).

As mentioned above, the groove (66) is formed so that the distance between its bottom surface confronting the basket and the interior surface of the basket gradually becomes narrower from the upstream toward the downstream side. Also, the groove (66) is inclined downwardly from the upstream toward the downstream side. Such configuration of each groove (66) causes the liquid having passed through the groove (66) to form a stream that impinges obliquely and downwardly against the accumulation of the microcapsules (94). The stream improves the scraping action of the scraper (60) to efficiently peel and disperse the microcapsules (94) accumulated on the inner surface of the peripheral wall (28) of the basket with a minimum pressing force to the microcapsules. The microcapsules (94) peeled out from the peripheral wall (28) of the basket are then sucked and collected by the liquid-transport pipe (90) of the liquid-transport device (40) as shown in FIG. 7. After the collection of the microcapsules (94), cleaning water is supplied into the basket (16) from the pipe of the cleaning device to wash away the residue in the basket (16).

As described above, no excessive stress is applied from the scraper (60) to the accumulation or microcapsules on the inner surface of the basket (16) during the scraping operation. This prevents the accumulation not only from being agglomerated on the interior surface of the basket (16) but also from being damaged. In particular, where the scraper (60) is moved intermittently toward the inner surface of the basket (16), the accumulation is more efficiently peeled away.

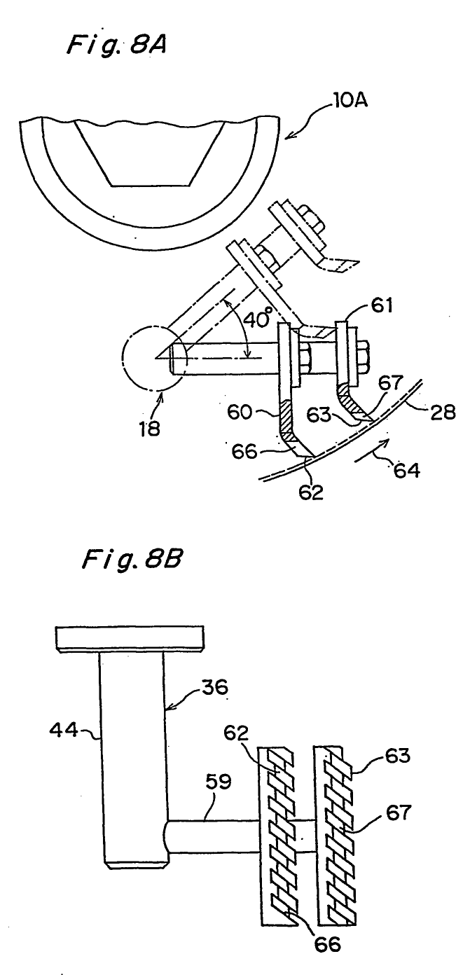

FIG. 8A shows a centrifugal separator (10A) according to the second embodiment of the present invention. The centrifugal separator (10A) is characterized in that it has first and second scrapers (60) and (61). With the arrangement of this centrifugal separator (10A), the accumulation on the inner surface (28) of the basket (16) suffers from two-time impingement of liquid caused by the first and second scrapers (60) and (61). This results in that the accumulation is removed from the inner surface of the basket so effectively within a reduced period of time when compared with the first embodiment.

In this embodiment, it is preferable that the teeth (62) and the grooves (66) of the first scraper (60) are shifted by a half pitch from the teeth (63) and the grooves (67) of the second scraper (61) in the vertical direction, as shown in FIG. 8B. By doing so, the liquid stream formed by the first scraper (60) and the liquid stream formed by the second scraper (61) impinge to the neighboring, different portions of the accumulation on the inner surface of the basket, respectively. Thus, it ensures the uniform impingement of the liquid stream impinges to every portion of the accumulation on the inner surface of the basket and also the uniform peeling of the accumulation therefrom.

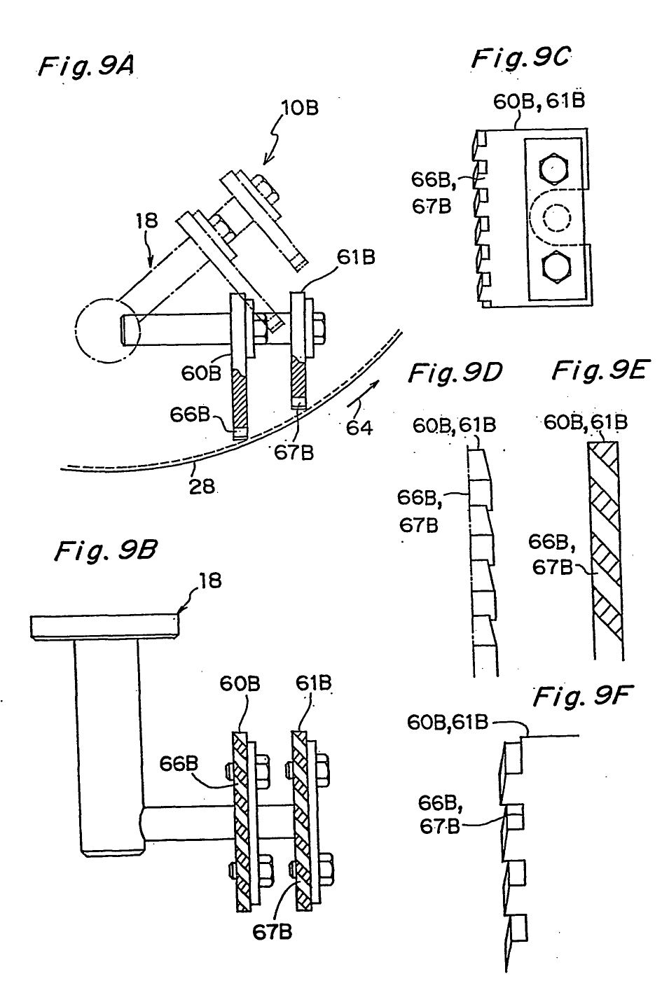

FIGS. 9A to 9F show a centrifugal separator (10B) according to the third embodiment of the present invention. In this centrifugal separator (10B), scrapers (60B) and (61B) are made from straight plates, respectively. The radial tip ends of the scrapers (60B) and (61B), confronting the interior surface of the basket, have grooves (66B) and (67B) as well as teeth formed between neighboring grooves. Similar to the previous embodiments, the grooves are inclined so that the liquid stream moving past the grooves are directed downwardly. According to the centrifugal separator (10B) of this embodiment, the accumulation on the inner surface of basket (16) can also be removed efficiently.

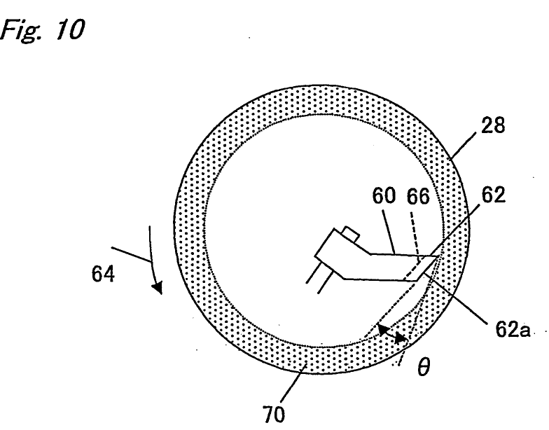

In designing the scraper (60), sizes of the elements such as vertical support (59), scraper (60) and portions of the scraper (60) should be determined carefully so that, as shown in FIG. 10, a peripheral end surface (62a) of tooth (62) defines a certain angle θ with a tangential line of the inner surface of the accumulation (70) on the upstream side of the surface when the tip end of the peripheral end surface (62a) becomes to contact with the accumulation (70). This prevents the peripheral end surface (62a) of the teeth (62) from pressing the accumulation (70) to form a consolidation of the solid content. The angle θ varies depending upon a thickness of the accumulation (70) to be formed on the peripheral wall (28).

Using two sustained-release microcapsules (1-month preparation and 3-month preparation), several tests were made to determined the suitable angle θ as follows:

Test 1

In test 1, a basket having an inner diameter of 225 mm was employed. The thickness of the accumulation was 5 mm. A scraper having a peripheral surface that defines 40° with the tangential line when the tip end of the peripheral end surface becomes to contact with the accumulation was used. As a result, the microcapsules were suitably dispersed without causing any consolidation.

Test 2

In test 2, a basket having an inner diameter of 350 mim was employed. The thickness of the accumulation was 2 cm. A scraper having a peripheral surface that defines the angle θ of 20° was used. As a result, the scraping and dispersing rate was decreased when compared with Test 1.

Test 3

In test 3, a scraper having a peripheral surface that defines the angle θ of 40° was used. Other conditions were the same as those in Test 2. As a result, the scraping and dispersing rate was increased.

From those tests, the angle e should be greater than zero, preferably 20°, and more preferably 40°.

As is apparent from the foregoing description, according to the present invention, the accumulation on the inner surface of the basket of the centrifugal separator can efficiently be peeled and separated therefrom with the minimum stress onto the accumulation.

1. A centrifugal separator (10) comprising:
a vertical shaft (14) connected to a driving system (15); and
a container (16) which rotates together with the vertical shaft (14);
the container (16) having
a round base plate (26) centering on the vertical shaft (14);
a peripheral wall (28) extending substantially parallel to the vertical shaft (14) and upwardly from a peripheral edge of the base plate (26); and
an annular top plate (30) extending inwardly from an upper end of the peripheral wall (28) toward the vertical shaft (14) and having therein a round opening (31) centering on the vertical shaft (14), so that the annular top plate (30) cooperates with the base plate (26) and the peripheral wall (28) to defines an annular space (32) therebelow;
whereby a suspension (92) made of a liquid and solid content and supplied into the container (16) is held in the annular space (32) and the solid content (94) is accumulated on the peripheral wall (28) by a centrifugal force caused by the rotation of the vertical shaft (14);
the centrifugal separator (10) further comprising a scraper (60) for scraping and separating an accumulation of the solid content (94) into pieces, the scraper (60) having a guide portion (62) which orients a liquid stream caused in the annular space (32) by the rotation of the container (16) and running in a peripheral direction into a downward, oblique direction toward the peripheral wall (28).

2. A scraping device (36) for use in a centrifugal separator (10), wherein the centrifugal separator (10) comprises a vertical shaft (14) connected to a driving system (15); and a container (16) which rotates together with the vertical shaft (14); the container (16) having a round base plate (26) centering on the vertical shaft (14); a peripheral wall (28) extending substantially parallel to the vertical shaft (14) and upwardly from a peripheral edge of the base plate (26); and an annular top plate (30) extending inwardly from an upper end of the peripheral wall (28) toward the vertical shaft (14) and having therein a round opening (31) centering on the vertical shaft (14), so that the annular top plate (30) cooperates with the base plate (26) and the peripheral wall (28) to defines an annular space (32) therebelow; whereby a suspension (92) made of a liquid and solid content and supplied into the container (16) is held in the annular space (32) and the solid content (94) is accumulated on the peripheral wall (28) by a centrifugal force caused by the rotation of the vertical shaft (14), comprising:
a scraper (60) for scraping and separating an accumulation of the solid content (94) into pieces, the scraper (60) having a guide portion (62, 66) which orients a liquid stream caused in the annular space (32) by the rotation of the container (16) and running in a peripheral direction into a downward, oblique direction toward the peripheral wall (28).

3. The scraping device according to claim 2, wherein the guide portion (62, 66) has a plurality of teeth (62) provided in the form of comb at regular intervals in the vertical direction and extending toward the peripheral wall (28), the teeth (62) defining grooves (66) therebetween for orienting the liquid stream in the downward, oblique direction.

4. The scraping device according to claim 3, wherein the scraping device (36) has at least two scrapers (60, 61) arranged so that the grooves (66) of one scraper (60) and the grooves (67) of the other scraper (61) can allow the liquid to flow toward different regions of the peripheral wall (28).

5. The scraping device according to any one of claims 2 to 4, further comprising a transport device. (46) for moving the scraper (60) toward the peripheral wall (28).

6. The scraping device according to claim 5, wherein the moving device (46) moves the scraper (60) toward the peripheral wall (28) continuously or intermittently.

7. A method for collecting a solid content (94) in a centrifugal separator (10), comprising the steps of:
rotating a peripheral wall (28) with a shaft (14) for holding a suspension (92) on the peripheral wall (8), the suspension being made of a liquid and solid content, so that the solid content is separated from the liquid and then accumulated on the peripheral wall (28) by a centrifugal force applied thereto;
moving a scraper (60) toward the peripheral wall (28) continuously or intermittently, the scraper (60) having a plurality of teeth (62) at regular intervals in a direction parallel to the shaft (14); and
guiding the liquid in a direction inclined at a certain angle to a rotational direction of the peripheral wall (28) to impinge the liquid onto the collected solid content (94), causing the solid content (94) to separate from another into pieces.
